(19) United States
(12) Patent Application Publication
(10) Pub. No.: US 2004/0076286 A1
(43) Pub. Date: Apr. 22, 2004

(54) Telephone circuit with a small, low-power ring trip monitor

(75) Inventor: Ronald Arthur Foerster, Petaluma, CA (US)

Correspondence Address: LAW OFFICES OF MARK C. PICKERING, P.O. BOX 300, PETALUMA, CA, 94953, US

(73) Assignee: Advanced Fibre Communication Inc.

(21) Appl. No.: 10/272,363

(22) Filed: Oct. 16, 2002

(51) Int. Cl. H04M 1/00; H04M 9/00; H04M 3/00

(52) U.S. Cl. 379/387.01; 379/413; 379/418

(57) ABSTRACT

The size and power consumption of a ring trip monitor circuit, which performs one of the BORSHT functions of a telephone line card, is reduced by utilizing an operational amplifier with feedback resistors, a resistor network, and a ring signal generator that is only connected to the line when a ring condition is present.

### BACKGROUND OF THE INVENTION

1. Field of the Invention

The present invention relates to telephone circuits and, more particularly, to a telephone circuit with a small, low-power ring trip monitor.

2. Description of the Related Art

A ring trip monitor is a circuit that detects when a ringing telephone has been answered. When a telephone call is placed, the central office places an oscillating voltage on the line that leads to the telephone. The ring trip monitor detects changes in the oscillating voltage that occur when the telephone has been answered so that the oscillating voltage can be removed from the line. A ring trip monitor performs one aspect of the Battery feed, Over voltage protection, Ringing, Supervision, Hybrid, and Test (BORSHT) function used in telephone line interfaces.

FIG. 1A shows a circuit diagram that illustrates a prior-art telephone circuit 100. As shown in FIG. 1A, circuit 100 includes a battery 110 that has a first terminal 112 and a second terminal 114, a ring relay 116 that is connected to first terminal 112, and a ring relay 118 that is connected to second terminal 114.

In addition, telephone circuit 100 has a line feed resistor LFR1 that is connected between terminal 112 and a ring node N1, and a line feed resistor LFR2 that is connected between terminal 114 and a tip PATENT node N2. Circuit 100 outputs a ring voltage RING on ring node N1, and a tip voltage TIP on tip node N2. Ring node N1 and Tip node N2 are connected to a telephone 115 via a twisted pair TP.

Circuit 100 also includes a ring generator 120 that outputs a ring signal RS. Generator 120 has an oscillator 122 that is connected to relay 116, and a negative voltage source 124 that is connected between oscillator 122 and ground. Voltage source 124 outputs a DC voltage of −48V, while oscillator 122 outputs an AC voltage. The AC voltage has a frequency of 20-30 Hz, an amplitude of 65-95V RMS, and a zero current crossing at the −48V DC bias when tip voltage TIP and ring voltage RING are terminated in an AC load. Ring relay 118, in turn, is connected to ground.

Further, circuit 100 includes a control circuit 126 that is connected to relays 116 and 118, and a ring trip monitor circuit 130. As further shown in FIG. 1A, ring trip monitor circuit 130 includes a comparator 132 that has a first input 134A, a second input 134B, and an output 136 that outputs a comparator voltage VC to control circuit 126. In addition, circuit 130 has a resistor R1 that is connected between tip node N2 and input 134A of comparator 132, and a resistor R2 that is connected between ring node N1 and input 134B of comparator 132.

Ring trip monitor circuit 130 also has a resistor R3 that is connected to terminal 114 on one side and both input 134B and resistor R2 on the other side, and a resistor R4 that is connected to terminal 112 on one side and both input 134A and resistor R1 on the other side.

Resistors R3/R2 and R1/R4 function as voltage dividers. (Line feed resistors LFR1 and LFR2 function as current limiting fuses, and are monitored by the ring trip monitor circuit for loop current. In addition, line feed resistors LFR1 and LFR2 are small in value compared to resistors R1-R4.) Resistors R2 and R3 are equal in value. Resistor R1 is slightly smaller than resistor R4, and resistor R3 is slightly larger than resistor R2. As a result, the voltage divider forms an input voltage V(+IN) on input 134A of comparator 132 and an input voltage V(−IN) on input 134B of comparator 132 that are offset from one another.

Further, ring trip monitor circuit 130 has a first capacitor C1 that is connected between input 134B of comparator 132 and ground, a second capacitor C2 that is connected between input 134A of comparator 132 and ground, and a capacitor C3 that is connected between inputs 134A and 134B of comparator 132.

Capacitor C1 and resistor R3, and capacitor C2 and resistor R4 function as low pass filters which keep the ring signal RS within the common mode range of comparator 132, while capacitor C3 limits the rate of change of the input voltages V(+IN) and V(−IN) on inputs 134A and 134B.

FIGS. 1B1-1B3 show timing diagrams that illustrate the operation of telephone circuit 100. FIG. 1B1 shows the tip voltage TIP and the ring voltage RING that are output from telephone circuit 100. FIG. 1B2 shows the input voltages V(+IN) and V(−IN) that are input to comparator 132, while FIG. 1B3 shows the comparator voltage VC output from comparator 132.

As shown in FIG. 1B1, at time t0 telephone 115 is on hook and no incoming call is present. In this state, no current flows out the tip node N2, through telephone 115, and back to the ring node N1. As a result, the ring voltage RING is equal to −48V, and the tip voltage TIP is equal to ground.

In addition, as shown in FIG. 1B1, due to the voltage divider provided by resistors R1-R4, input voltage V(+IN) is slightly more positive than input voltage V(−IN) at this time which, as shown in FIG. 1B3, causes comparator 132 to output the comparator voltage VC as a logic high (at 5V).

At time t1, a call is placed to telephone 115. Control circuit 126 detects the incoming call and outputs control signals CS1 and CS2 to relays 116 and 118, respectively, to open relays 116 and 118. As a result, the ring signal RS is connected to line feed resistor LFR1 and resistor R4 (and is output to telephone 115 via the ring node N1), while line feed resistor LFR2 and resistor R3 are connected to ground.

As further shown in FIG. 1B2, when relay 116 connects the ring signal RS to resistor R4, the input voltages V(+IN) and V(−IN) begin to oscillate substantially in phase, with input voltage V(+IN) continuing to have a slightly higher voltage than input voltage V(−IN). As a result, as shown in FIG. 1B3, comparator 132 continues to output the comparator voltage VC with a logic high (at 5V). From time t1 to time t2, only an AC current flows out to telephone 115 via twisted pair TP.

When telephone 115 is answered at time t2, the off hook condition causes the AC current and a DC current I to flow from ground through line feed resistor LFR2 out the tip node N2 to telephone 115, and back via the ring node N1 to battery terminal 112. As shown in FIG. 1B1, the DC current I causes the tip voltage TIP to become more negative and the ring voltage to become more positive.

When telephone 115 is answered, the impedance of the line changes from the AC impedance of the ringer in telephone 115 to the DC impedance of the line plus telephone 115, which is much lower than the AC impedance. The AC ring voltage and the DC battery voltage divide per Ohm's Law across the line feed resistors LFR1 and LFR2, the resistance of the line, and the DC resistance of telephone 115.

As shown in FIG. 1B2, this changes the input voltages V(+IN) and V(−IN) so that input voltage V(−IN) is now more positive than input voltage V(+IN). As shown in FIG. 1B3, the changes in the input voltages V(+IN) and V(−IN) are detected by comparator 132 which, at time t3, changes the logic state of the comparator voltage VC to a logic low (represented as ground). The logic low is detected by controller 126 which then changes the logic states of the control signals CS1 and CS2, thereby closing relays 116 and 118 at time t4.

One problem with telephone circuit 100 is that capacitors C1-C3 are quite large. As a result, capacitors C1-C3 consume a significant amount of circuit board space. One approach to reducing the size of circuit 100 is to use a telephone circuit that utilizes a differential amplifier.

FIG. 2A shows a circuit diagram that illustrates a prior art telephone circuit 200 that utilizes a differential amplifier. As shown in FIG. 2A, circuit 200 includes a battery 210 that has a first terminal 212A that outputs a first voltage, such as −48V, and a second terminal 212B that outputs a second voltage, such as ground. In addition, battery 210 has a reference terminal 214 that outputs a reference voltage VREF, such as +1.5V. Further, circuit 200 includes a line feed resistor LFR1 that is connected to terminal 212A, and a line feed resistor LFR2 that is connected to terminal 212B.

Circuit 200 also includes a ring relay 216 that is connected to resistor LFR1 and a ring node N1, and a ring relay 218 that is connected to resistor LFR2 and a tip node N2. Circuit 200 outputs a ring voltage RING on ring node N1, and a tip voltage TIP on tip node N2. Ring node N1 and Tip node N2 are connected to a telephone 217 via a twisted pair TP.

Further, circuit 200 includes a ring generator 220 that outputs a ring signal RS. Generator 220 has a voltage source that outputs a DC voltage of −48V, and an oscillator that outputs an AC signal that has a frequency of 20-30 Hz, an amplitude of 65-95V RMS, and a zero current crossing at the −48V DC bias when tip voltage TIP and ring voltage RING are terminated in an AC load. Further, circuit 200 includes a control circuit 226 that is connected to relays 216 and 218, and a ring trip monitor circuit 230.

As further shown in FIG. 2A, ring trip monitor circuit 230 includes a differential amplifier 232 that has a positive input 234A, a negative input 234B, and an output 236 that outputs a voltage VC to control circuit 226. In addition, circuit 230 has a resistor RB1 that is connected between ring generator 220 and the positive input 234A of amplifier 232, and a resistor RB2 that is connected between input 234B of amplifier 232 and ground. Circuit 230 also has a resistor RB3 that is connected between relay 216 and the negative input 234B of amplifier 232, and a resistor RB4 that is connected to the positive input 234A of amplifier 232 and resistor RB1.

In addition, circuit 230 includes a sense resistor RN1 that is connected between resistor RB3 and generator 220, and a sense resistor RN2 that is connected between resistor RB4 and ground. Resistors RN1 and RB3 are connected to a first intermediate node NM1, and an intermediate voltage V(−IN) is measured at node NM1. Resistors RN2 and RB4 are connected to a second intermediate node NM2, and an intermediate voltage V(+IN) is measured at node NM2.

Further, ring trip monitor circuit 230 has a feedback resistor RF1 that is connected between output 236 and input 234B, and a feedback resistor RF2 that is connected between input 234A and reference terminal 214. In addition, resistors RF1 and RF2 divide down the voltage to the common mode range of amplifier 232.

FIGS. 2B1-2B3 show timing diagrams that illustrate the operation of telephone circuit 200. FIG. 2B1 shows the tip voltage TIP and the ring voltage RING that are output from telephone circuit 200. FIG. 2B2 shows the intermediate voltages V(+IN) and V(−IN), while FIG. 2B3 shows the differential voltage VC output from differential amplifier 232.

As shown in FIG. 2B1, at time t0 telephone 217 is on hook and no incoming call is present. In this state, no current flows out the tip node N2, through telephone 217, and back to the ring node N1. As a result, the ring voltage RING is equal to −48V, and the tip voltage TIP is equal to ground. In addition, as shown in FIG. 2B2, intermediate voltage V(+IN) is equal to ground, while intermediate voltage V(−IN) oscillates about −48V with positive peaks.

Resistors RB1-RB4, which are equal in value (e.g., 2MΩ), function as voltage dividers which, in part, define the voltages on inputs 234A and 234B. Line feed resistors LFR1 and LFR2 function as current limiting fuses, and are small, equal in value (e.g., 150Ω), and monitored by the ring trip monitor circuit for loop current. Resistors RF1 and RF2 are also equal (e.g., 68KΩ). Thus, as shown in FIG. 2B3, to insure that the voltages on inputs 234A and 234B remain equal, amplifier 232 sets the value of output voltage VC equal to the reference voltage VREF (e.g., +1.5V).

At time t1, a call is placed to telephone 217. Control circuit 226 detects the incoming call and outputs control signals CS1 and CS2 to relays 216 and 218, respectively, to open relays 216 and 218. As a result, the intermediate voltage V(−IN) is connected to the ring node N1 (and output to the telephone via the ring node N1), while the tip node N2 is connected to ground via sense resistor RN2.

When relay 216 connects the intermediate voltage V(−IN) to the ring node N1, a small current flows through sense resistor RN2. The small current causes the intermediate voltage V(+IN) to oscillate slightly, thereby causing the output of differential amplifier 232 to oscillate slightly around the positive logic high voltage (e.g., +1.5V).

When telephone 217 is answered at time t2, the off hook condition causes a DC current I to flow from ground through line feed resistor LFR2 and sense resistor RN2 out the tip node N2 to telephone 217, and back via the ring node N1. As shown in FIG. 2B1, the DC current I causes the tip voltage TIP to begin oscillating, while the magnitude of the oscillating ring voltage RING falls slightly.

As shown in FIG. 2B2, the changes also cause the intermediate voltage V(+IN) to begin oscillating, and the magnitude of the intermediate voltage V(−IN) to fall slightly. As shown in FIG. 2B3, the changes in the intermediate voltages V(+IN) and V(−IN) cause amplifier 232 to begin to oscillate the differential voltage VC to insure that the voltages on inputs 234A and 234B remain equal.

The average DC value of the differential voltage VC is offset when telephone 217 is answered (off-hook), the magnitude of the offset depending on the battery, loop length, and load. When the average DC value exceeds a detection threshold that is set in control circuit 236 for a predefined period of time, controller 226 detects a ring trip and changes the logic states of the control signals CS1 and CS2, thereby closing relays 216 and 218 at time t3.

One problem with telephone circuit 200 is that ring trip monitor circuit 230 is always connected to the ring generator, and always drawing current. Even though the values of resistors RB1-RB4 are quite high, in large phone exchanges one ring generator may be shared by hundreds of lines. Thus, the cumulative current drawn is significant.

Another short coming of this circuit is that to keep the load on the ring generator to a minimum, resistors RB1-RB4 are quite high in value. This causes the ring trip to be less stable due to offset currents and voltages from differential amplifier 232, and variations due to temperature, humidity, and manufacturing processes.

Thus, there is a need for a telephone circuit with a ring trip monitor circuit that is small in size, uses fewer components, and is less power demanding.

### SUMMARY OF THE INVENTION

The present invention provides a telephone circuit that has a small, low-power ring trip monitor. The telephone circuit includes a ring trip monitor circuit that has an amplifier with a positive input, a negative input, and an output. The ring trip monitor circuit also has a reference resistor that is connected to the positive input and a voltage reference, and a feedback resistor that is connected to the negative input and the output.

The ring trip monitor circuit further has a first voltage divider that has a node connected to the positive input and a node connected to a tip node. In addition, the ring trip monitor circuit has a second voltage divider that has a node connected to the negative input and a node connected to the ring node.

Further, the telephone circuit includes a first relay that is connected to a node of the first voltage divider, and a second relay that is connected to a node of the second voltage divider. The telephone circuit additionally includes a ring signal generator that is connected between the first relay and ground.

A better understanding of the features and advantages of the present invention will be obtained by reference to the following detailed description and accompanying drawings which set forth an illustrative embodiment in which the principals of the invention are utilized.

### BRIEF DESCRIPTION OF THE DRAWINGS

FIG. 1A is a circuit diagram illustrating a prior-art telephone circuit 100.

FIGS. 1B1-1B3 are timing diagrams illustrating the operation of telephone circuit 100. FIG. 1B1 shows the tip signal TIP and the ring signal RING that are output from telephone circuit 100. FIG. 1B2 shows the input signals IN+ and IN− that are input to comparator 132, and FIG. 1B3 shows the output of comparator 132.

FIG. 2A is a circuit diagram illustrating a prior art telephone circuit 200 that utilizes an differential amplifier.

FIGS. 2B1-2B3 are timing diagrams illustrating the operation of telephone circuit 200. FIG. 2B1 shows the tip voltage TIP and the ring voltage RING that are output from telephone circuit 200. FIG. 2B2 shows the intermediate voltages V(+IN) and V(−IN), while FIG. 2B3 shows the differential voltage VC output from differential amplifier 232.

FIG. 3A is a circuit diagram illustrating an example of a telephone circuit 300 in accordance with the present invention.

FIGS. 3B1-3B3 are timing diagrams illustrating the operation of telephone circuit 300. FIG. 3B1 shows the tip voltage TIP and the ring voltage RING that are output from telephone circuit 300. FIG. 3B2 shows the terminal voltages V(−IN) and V(+IN), while FIG. 3B3 shows the differential voltage VC output from amplifier 332.

### DETAILED DESCRIPTION

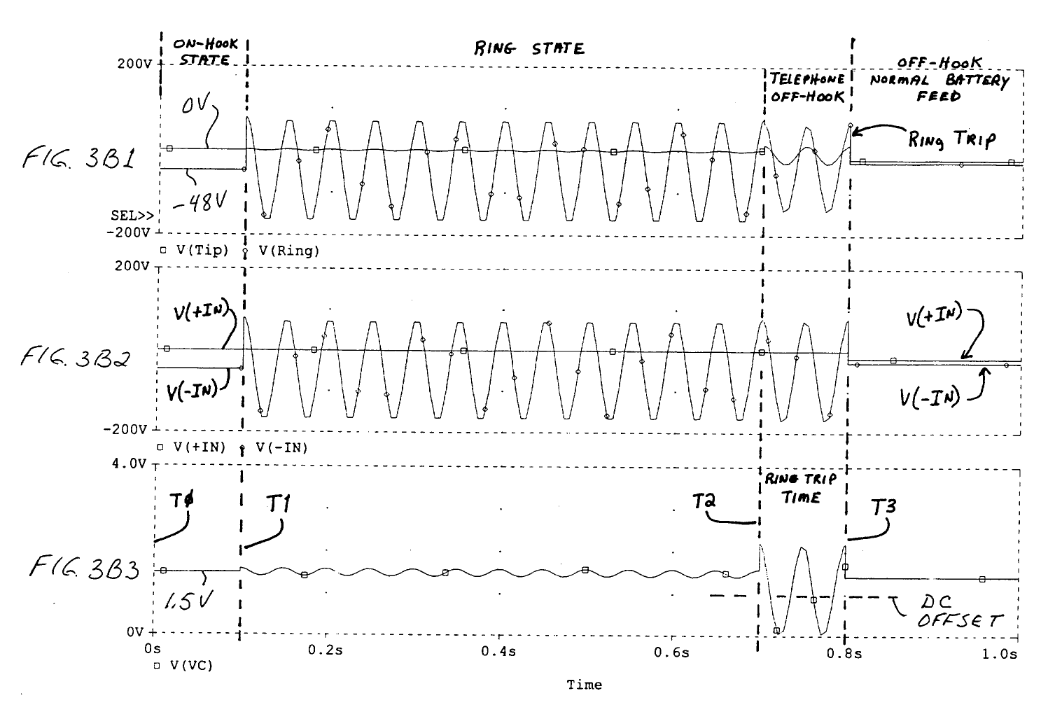

FIG. 3A shows a circuit diagram that illustrates an example of a telephone circuit 300 in accordance with the present invention. As shown in FIG. 3A, circuit 300 includes a battery 310 that includes a first terminal 312A that has a first intermediate voltage V(−IN), such as −48V, and a second terminal 312B that has a second intermediate voltage V(+IN), such as ground.

Battery 310 also has a reference terminal 314 that outputs a reference voltage VREF such as, for example, 1.5V. (Battery 310 can include circuitry that protects the battery from lightning strikes and other high energy conditions.) In addition, circuit 300 includes a ring relay 316 that is connected to first terminal 312A, and a ring relay 318 that is connected to second terminal 312B and ground.

In addition, circuit 300 has a line feed resistor LFR1 that is connected between first terminal 312A and a ring node N1, and a line feed resistor LFR2 that is connected between second terminal 312B and a tip node N2. (The line feed resistor values are generally slightly larger than a standard value resulting in a shorter supervision range.) Circuit 300 outputs a ring voltage RING on ring node N1, and a tip voltage TIP on tip node N2. Ring node N1 and Tip node N2 are connected to a telephone 319 via a twisted pair TP.

Circuit 300 also includes a ring signal generator 320 that outputs an oscillating ring signal RG. Generator 320 has an oscillator 322 that is connected to relay 316, and a negative voltage source 324 that is connected between oscillator 322 and ground. Oscillator 322 outputs an AC signal that has a frequency of, for example, 20-30 Hz and an amplitude of, for example, 65-95V RMS, while voltage source 324 outputs a DC voltage of, for example, −48V. Further, circuit 300 includes a control circuit 326 that is connected to relays 316 and 318, and a ring trip monitor circuit 330.

As further shown in FIG. 3A, ring trip monitor circuit 330 includes a differential amplifier 332 that has a positive input 334A, a negative input 334B, and an output 336 that outputs a differential voltage VC to control circuit 326. In addition, circuit 330 has a first resistor R1 that is connected between tip node N2 and input 334A of amplifier 332, and a second resistor R2 that is connected between ring node N1 and input 334B of amplifier 332.

Ring trip monitor circuit 330 also has a third resistor R3 that is connected to terminal 312B through the normally closed contacts of ring relay 318 on one side and both input 334B and resistor R2 on the other side. In addition, ring trip monitor circuit 330 has a fourth resistor R4 that is connected to terminal 312A through the normally closed contacts of ring relay 316 on one side and both input 334A and resistor R1 on the other side. Further, ring trip monitor circuit 330 has a fifth resistor R5 that is connected between reference terminal 314 and input 334A, and a sixth resistor R6 that is connected between output 336 and input 334B.

FIGS. 3B1-3B3 show timing diagrams that illustrate the operation of telephone circuit 300. FIG. 3B1 shows the tip voltage TIP and the ring voltage RING that are output from telephone circuit 300. FIG. 3B2 shows the terminal voltages V(−IN) and V(+IN), while FIG. 3B3 shows the differential voltage VC output from amplifier 332.

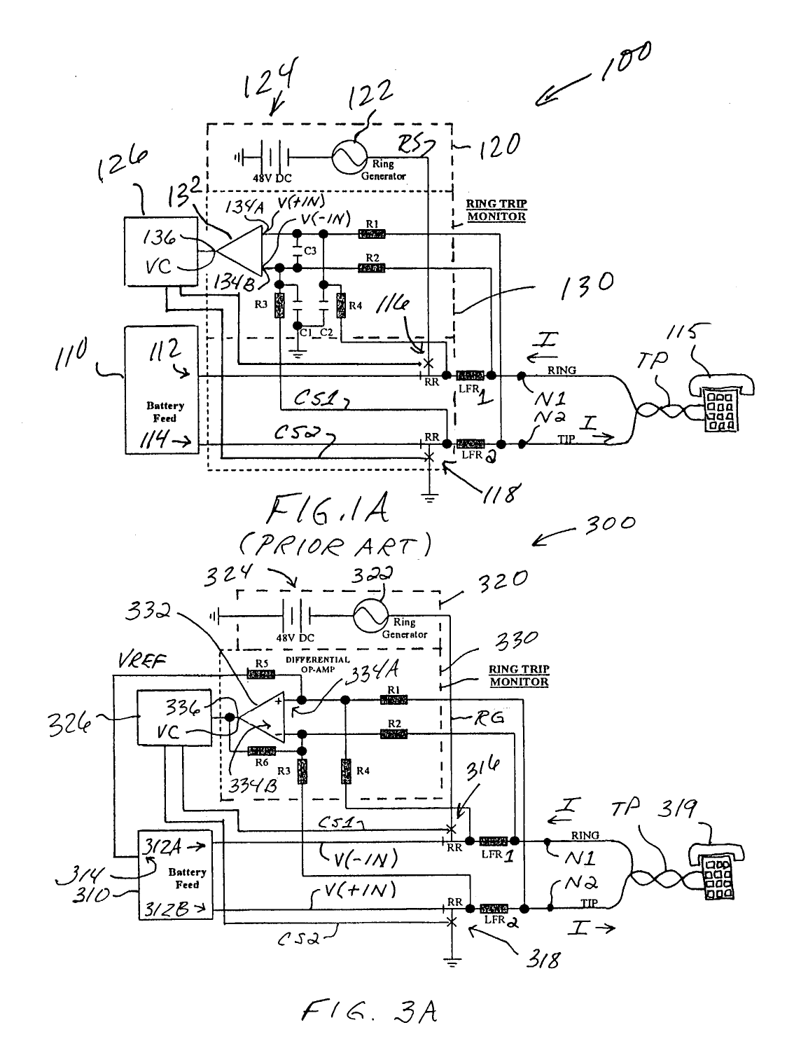

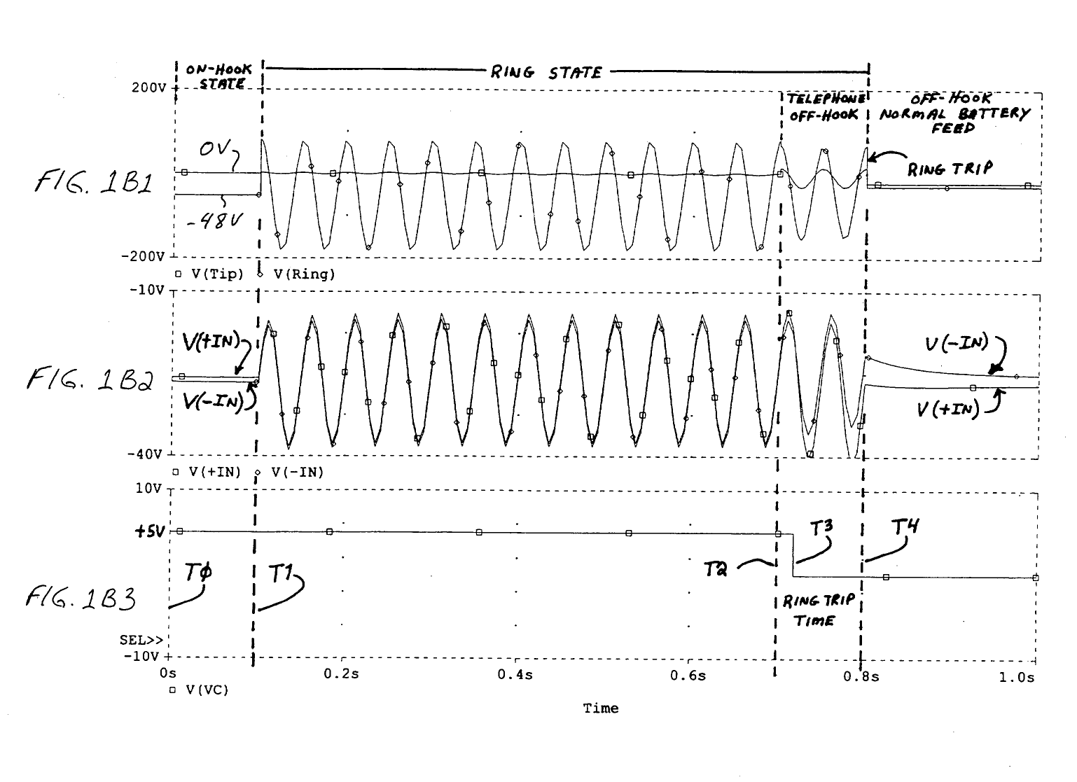

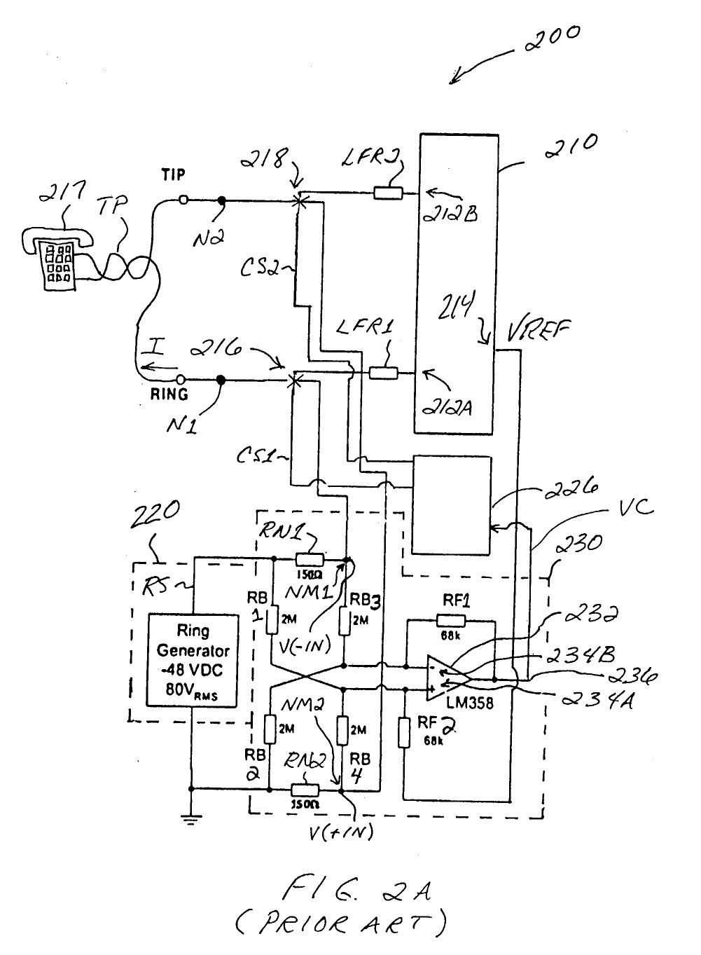

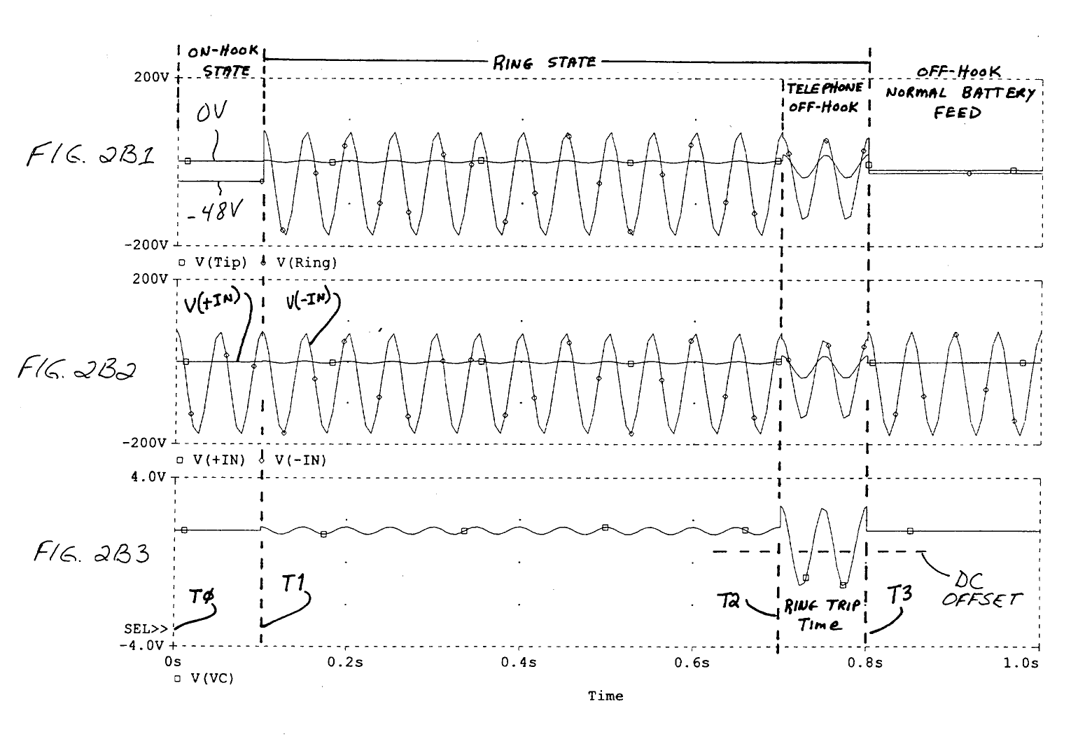

As shown in FIG. 1B1, at time t0 telephone 319 is on hook and no incoming call is present. In this state, there is no current flowing out the tip node N2, through telephone 319, and back to the ring node N1. As a result, the intermediate and ring voltages V(−IN) and RING are both equal to −48V DC, and the intermediate and tip voltages V(+IN) and TIP are both equal to ground.

Resistors R3/R2 and R1/R4, which are equal in value (e.g., 400KΩ), function as voltage dividers which, in part, define the voltages on inputs 334A and 334B. Line feed resistors LFR1 and LFR2 function as current limiting fuses, and are small, equal in value (e.g., 100Ω), and monitored by the ring trip monitor circuit for loop current.

Resistors R5 and R6 are also equal. Thus, as shown in FIG. 3B3, to insure that the voltages on inputs 334A and 334B remain equal, amplifier 332 sets the value of output voltage VC equal to the reference voltage VREF (e.g., +1.5V). Further, resistors R3 and R6 divide down the voltage to the common mode range of amplifier 332 to prevent the differential voltage VC output from amplifier 332 from exceeding the input and output voltage range.

At time t1, a call is placed to telephone 319. Control circuit 326 detects the incoming call and outputs control signals CS1 and CS2 to relays 316 and 318, respectively, to open relays 316 and 318. As a result, the ring signal RG is connected to line feed resistor LFR1 and resistor R4 (and is output to telephone 319 via the ring node N1), while line feed resistor LFR2 and resistor R3 are connected to ground.

As shown in FIGS. 3B1 and 3B2, when relay 316 connects the oscillating voltage to line feed resistor LFR1, the intermediate voltage V(−IN) and the ring voltage RING are slightly out of phase. (The intermediate voltage V(+IN) and the tip voltage TIP remain equal to ground.) As shown in FIG. 3B3, when the intermediate voltage V(−IN) and the ring voltage RING are slightly out of phase, the differential voltage VC oscillates slightly about the reference voltage VREF.

When telephone 319 is answered at time t2, the off hook condition causes a DC current I to flow from ground through line feed resistor LFR2 out the tip node N2 to telephone 319, and back via the ring node N1 to battery terminal 312. As shown in FIG. 3B1, the DC current I causes the tip voltage TIP to begin oscillating, while the magnitude of the oscillating ring voltage RING falls slightly. This is due to the change from the relatively high AC impedance of the ringer in telephone 319 to the DC resistance of telephone 319 when telephone 319 was taken off hook.

As shown in FIG. 3B3, the changes in the ring and tip voltages RING and TIP cause amplifier 332 to begin to oscillate the differential voltage VC. During the ring state between times t1 and t2, very little AC current and no DC current is flowing from the ring generator to the telephone to ground. Therefore, as shown in FIG. 3B3, there is little output from differential amplifier 332. At time t2, telephone 319 goes off hook. When this happens, both AC and DC current begin to flow.

From time t2 to time t3, the difference voltage across resistors LFR1 and LFR2 is much higher, resulting in a much larger signal at differential output VC. In addition, the AC signal is DC offset by the current from the ring generator 320 DC source 324. The average DC value of the differential voltage VC is offset when telephone 319 is answered (off-hook), the magnitude of the offset depending on the battery, loop length, and load.

A detection threshold is set in control circuit 336. When the average DC value exceeds the threshold for a predefined period of time, controller 326 detects a ring trip and changes the logic states of the control signals CS1 and CS2, thereby closing relays 316 and 318 at time t3. The ring trip time (t3-t2) is a function of where in the ring cycle telephone 319 is answered (off-hook), the ring frequency, the ring voltage AC and DC, the loop length, and the ringer load.

One advantage of telephone circuit 300 is that telephone circuit 300 does not require capacitors as does circuit 100. The capacitors in circuit 100 are quite large and occupy a significant amount of circuit board space. Thus, by eliminating the capacitors, the present invention allows smaller circuit boards to be utilized or, alternately, more circuitry can be incorporated on the same sized circuit board.

Another advantage of telephone circuit 300 is that ring trip monitor circuit 330 has no standby power consumption as does telephone circuit 200. Unlike circuit 200, circuit 300 provides a load to ring signal generator 320 only when the ring signal RG is placed on the line. As a result, a smaller power supply can be utilized, and less cooling is required.

A further advantage is that the present invention can be used on both balanced and unbalanced lines. Unbalanced ringing is primarily used in North America and is defined as an AC voltage which has a frequency in the range 15-60 Hz (typically 20-30 Hz) that is superimposed on a battery (typically −48V). The superimposed AC is normally applied to the ring lead with the tip lead providing a ring ground return.

Balanced ringing occurs when the superimposed signals are simultaneously applied to the ring and tip leads 180° out of phase with each other. Each AC source is balanced ring-to-ground and tip-to-ground. Further, each AC source is DC offset so that the ring lead is generally more negative than the tip lead.

Other advantages of the present invention are that a ring trip sense can be done under normal loop closure as well as a ring ground fault or tip power fault. Further, circuit 300 does not require a separate high wattage fault tolerant sensing resistor. In addition, resistors R1-R4 of circuit 300 can have lower values, resulting in more reliable and stable operation.

It should be understood that the above description is an example of the present invention, and various alternatives to the embodiment of the invention described herein may be employed in practicing the invention. Thus, it is intended that the following claims define the scope of the invention and that methods and structures within the scope of these claims and their equivalents be covered thereby.

What is claimed is:

1. A telephone circuit comprising:
a ring trip monitor having:
an amplifier having a positive input, a negative input, and an output;
a reference resistor connected to the positive input and a voltage reference;
a feedback resistor connected to the negative input and the output;
a first voltage divider, the first voltage divider having a node connected to the positive input and a node connected to a tip node; and
a second voltage divider, the second voltage divider having a node connected to the negative input and a node connected to the ring node; and
a first relay connected to a node of the first voltage divider;
a second relay connected to a node of the second voltage divider; and
a ring signal generator connected between the first relay and ground.

2. The telephone circuit of claim 1 and further comprising a control circuit connected to the output of the amplifier, the first relay, and the second relay.

3. The telephone circuit of claim 1 and further comprising:
a battery having a first terminal and a second terminal;
a first line feed resistor formed between the first terminal and the ring node; and
a second line feed resistor formed between the second terminal and the tip node.

4. The telephone circuit of claim 3 wherein the first end of the first line feed resistor is connected to the first voltage divider and the second end of the first line feed resistor is connected to the second voltage divider.

5. The telephone circuit of claim 4 wherein the first end of the second line feed resistor is connected to the second voltage divider and the second end of the second line feed resistor is connected to the first voltage divider.

6. The telephone circuit of claim 1 wherein the ring signal generator includes:
an oscillator connected to the first relay; and
a negative DC voltage source connected between the oscillator and ground.

7. The telephone circuit of claim 3 wherein the first line feed resistor and the second line feed resistor are approximately equal.

8. The telephone circuit of claim 7 wherein the first voltage divider has a plurality of first divider resistors, and the second voltage divider has a plurality of second divider resistors.

9. The telephone circuit of claim 8 wherein the first and second divider resistors are substantially equal in value.

10. The telephone circuit of claim 9 wherein the first and second divider resistors are substantially larger than the first and second line resistors.

11. The telephone circuit of claim 1 and further comprising a ring signal generator connected between the second relay and ground.
